(19) United States
(12) Patent Application Publication
(10) Pub. No.: US 2024/0083159 A1
(43) Pub. Date: Mar. 14, 2024

(54) PRINT HEAD

(71) Applicant: Oxford University Innovation Limited, Oxford (Oxfordshire) (GB)

(72) Inventors: Hazel E. ASSENDER, Oxford (Oxfordshire) (GB); Bryan W. STUART, Oxford (Oxfordshire) (GB); Gemma L. FRANCIS, Oxford (Oxfordshire) (GB)

(21) Appl. No.: 17/766,840

(22) PCT Filed: Oct. 1, 2020
(86) PCT No.: PCT/GB2020/052405

§ 371 Date: Apr. 6, 2022

(30) Foreign Application Priority Data
Oct. 8, 2019 (GB) 1914539.0

(51) Int. Cl. B41F 5/24; B41N 1/12

(52) U.S. Cl. CPC B41F 5/24; B41N 1/12; B41C 2210/16

(57) ABSTRACT

A print head for use in a flexographic process, the print head comprising a flat surface having a first portion with a first surface energy and a second portion with a second surface energy that is different from the first surface energy.

The present disclosure relates to a print head, such as one suitable for use in a flexography process, particularly but not necessarily exclusively a roll-to-roll flexography process, or in a micro contact printing process. The invention also relates to a method of producing such a print head and to the use of such a print head in the manufacture of one or more products, e.g. electronic products.

Flexography is a printing process that utilises a print head to print onto a surface. Commonly, such a print head is formed by a flexible relief plate that uses a profiled surface to selectively apply inks or other liquids onto a substrate. Typically, the print head may be made from a rubber and the features on the profiles surface are present on the millimetre scale. Raised portions of the print head deposit the liquid onto the substrate whilst the non-raised portions do not deposit any liquid. Thus, a pattern can be printed onto the substrate. Such a technique is well-established and will not be further discussed here.

Microcontact printing also utilises a print head. In contrast to flexography, the ink to be applied is poured over the print head and allowed to dry. In the process, ink is absorbed into the bulk of the print head, creating an ink well. Bringing the print head into contact with a substrate then deposits ink from raised portions of the print head. This technique is also well-established and will not be further discussed here.

Relief-based printing techniques such as flexography are now used to produce electronic products through the use of a technique known as “selective metallisation”. Selective metallisation enables the patterning of metals in layers with a thickness on the nanometre scale by thermally evaporating a desired metal towards a low vapour pressure oil mask. Suitable constituents of the oil mask include those sold under the Krytox® and Fomblin® names, manufactured by The Chemours Company and Solvay respectively. The oil mask inhibits the deposition of the metal, resulting in a patterned deposition of a metal layer. Other printing techniques other than selective metallisation are also possible, for example those using water-based inks.

Current relief-printing techniques are limited by the spreading of liquids, in this case the liquid making up the oil mask, during the compression of the print head onto the substrate. This limits the resolution of the deposited oil. Resolution is also limited by deformation of the raised portions of the profiled print head as the print head is pressed against the substrate.

Some relief-printing techniques, such as a recently-developed technique using a print head utilising aligned carbon nanotubes, offer improved resolution over well-known print heads. However, these suffer from other drawbacks such as the inability to be used in a roll-to-roll printing process.

According to a first aspect, there is provided a print head for use in a flexographic process, the print head comprising a surface having a first portion with a first surface energy and a second portion with a second surface energy that is different from the first surface energy.

Having two portions of the print head with different surface energies, the wettability of each of the portions will be different. Once coated with a liquid for application, this will result in an uneven distribution of the liquid on the print head which can then be transferred to a substrate. This uneven distribution is caused by surface forces more strongly confining the liquid in one of the portions compared to the other. This negates the need for a print head to have a contoured or profiled surface in order to print a desired pattern onto a substrate. Print heads may therefore be able to be produced more cheaply, without any need to etch or otherwise form a three-dimensional pattern on the print head. Moreover, as the print head is a flat surface, there is no issue with deformation of raised portions of the print head when the print head is compressed onto a substrate during the printing process. This therefore provides a greater accuracy of printing.

The surface may be a flat surface. By flat surface, it is meant that the surface of the print head is free from profiling or contours. However, a flat surface may be planar or may be, for example, curved or cylindrical. This may be advantageous for providing a continuous printing process such as roll-to-roll.

The surface may be a profiled surface. Altering the surface energy of a profiled surface may help to enhance the definition provided by the surface through increased adhesion of the liquid to the print head.

The difference in surface energy may cause localised de-wetting of a liquid applied to the print head. This acts to limit spread of the liquid over the print head during the printing process.

The print head may be planar. Such a print head may be useful in a non-continuous printing process.

Alternatively, the print head may be cylindrical or may constitute a portion of a cylinder and/or may be rotatable about an axis. Such a print head may be useful in a continuous printing process such as roll-to-roll printing.

The flat surface may comprise an elastomeric material such as a rubber. The elastomeric material may include polydimethylsiloxane (PDMS), photopolymers such as nyloflex, butadiene, or nitrile elastomers.

The difference in the first surface energy and the second surface energy may be provided by a chemical process such as an ultraviolet ozone irradiation process.

Ultraviolet ozone irradiation causes surface changes in the material, e.g. PDMS, in the print head, which affects the surface energy of the portions of the material exposed. Exposure can be prevented from reaching some portions of the material by use of a shadow mask.

In a chemical process, a mask is used to localise the area of the chemical treatment.

The difference in the first surface energy and the second surface energy may be provided by a radiation process such as an electron beam treatment process, an ion beam treatment process, or a direct UV irradiation process. The electron beam treatment process may comprise selectively irradiating one or more portions of the flat surface to modify the surface energy of the irradiated portion(s). The ion beam treatment process may comprise selectively irradiating one or more portions of the flat surface to modify the surface energy of the irradiated portion(s).

In a radiation process, two possible means may be used to provide the localised modification of surface energy: (a) a mask can be used to block specific areas from radiation delivered to a whole area, or (b) a focussed beam of radiation, i.e. an image or a raster of a beam, can be provided.

In each case, the radiation should have sufficient energy to initiate chemical reaction in the surface. Photopolymers are tailored for such applications. In contrast to conventional print heads, in the present provides, the reaction must only be sufficient to modify the surface energy and does not need to be sufficient to etch or ‘wash away’ material.

Where PDMS is the material used for the print head, a focussed electron beam may be used to locally expose the surface. For example a 5 kV electron beam may be used for 45 seconds of radiation treatment to provide the surface energy modification.

Where a direct UV irradiation process, a short wavelength may be used in order that no photoinitiator is required.

According to a second aspect, there is provided a method of producing a print head for use in a flexographic process, the method comprising:
a modification step of modifying a surface energy of a first portion of a surface of a print head such that it is different from a surface energy of a second portion of a surface of a print head.

Modification of the surface energy of a first portion of the print head means that the wettability of each of the portions will be different.

The surface may be a flat surface. A flat surface may be simpler to produce. Moreover, it may be possible to effectively reprogram the print head by subsequent further modification of the surface energy.

The method may further comprise a preparation step of applying a shadow plate to the print head for acting as a stencil during the modification step.

The modification step may include applying ultraviolet ozone irradiation to the print head through the shadow plate.

The ultraviolet ozone irradiation may be applied for a period of up to or at least 15 minutes, up to or at least 30 minutes, up to or at least 1 hour, up to or at least 2 hours, up to or at least 3 hours and/or up to or at least 4 hours.

The modification step may include an electron beam treatment process or an ion beam treatment process. The electron beam treatment process may comprise selectively irradiating one or more portions of the flat surface to modify the surface energy of the irradiated portion(s). The ion beam treatment process may comprise selectively irradiating one or more portions of the flat surface to modify the surface energy of the irradiated portion(s).

According to a third aspect, there is provided a flexography apparatus comprising:
a print head according to the first aspect; and
an applicator configured to apply a liquid to the print head.

The flexography apparatus may further comprise a roll-to-roll substrate feeder configured to pass substrate from a first roll, past the print head for printing of the substrate, and on to a second roll. The apparatus may then be suitable for continuous or substantially continuous operation.

The print head may be cylindrical or may constitute a portion of a cylinder and/or may be rotatable about an axis, the applicator continuously applying liquid to the print head as the print head rotates.

The applicator may comprise an anilox roller for applying liquid to the print head by physical contact with the print head.

Alternatively, the applicator may comprise an evaporator that evaporates liquid onto the print head.

The liquid may be an oil, such as Krytox® (polyhexafluoropropylene oxide) or Fomblin® copolymer of hexafluoropropylene oxide and difluoromethyleneoxide. Polymeric hydrocarbon oils such as polyalphaolefin may also be used, or silicone oils.

Alternatively, the liquid may be a water-based ink.

According to a fourth aspect, there is provided a method of patterning a substrate, comprising:
a printing step of printing a liquid mask onto a first portion of a substrate using a print head according to the first aspect; and
a patterning step of applying a material layer to a second portion of the substrate, wherein the liquid mask has not been applied to the second portion.

The patterning step may comprise use of an evaporation process, sputtering, physical vapour deposition, chemical vapour deposition (CVD), thermal evaporation, e-beam evaporation, ion beam deposition, pulsed laser deposition, cathodic arc deposition, atomic layer deposition, or high-power impulse magnetron sputtering (HIPIMS).

The method may be carried within a roll-to-roll flexography process. This may allow for continuous or semi-continuous printing onto the substrate and/or patterning.

The print head may be cylindrical or may constitute a portion of a cylinder and/or may be rotatable around an axis.

Alternatively, the print head may be planar.

Liquid may be provided to the print head during every rotation of the print head. This may facilitate continuous printing.

The material layer may comprise a functional or non-functional layer. For example, the material layer may comprise one or more of: a metal such as silver, aluminium or copper; a semiconductor; an oxide; a molecular organic material (for example a molecular organic semiconductor such as pentacene); and/or a polymer. The composition of the material layer may be varied depending upon the nature of the product that is being manufactured using the patterning process.

The material layer may comprise a functional material such as a semiconductor. Functional devices can therefore be obtained, such as transistors.

The method may further comprise a modification step of modifying the surface energy of a portion of the print head. The print head may therefore be adapted to alter the pattern printed onto the substrate during any subsequent printing step, without changing the print head.

The method may further comprise a modification step of replacing the print head with a further print head according to the first aspect, prior to a further printing step.

The modification step may take place between multiple printing steps.

One or both of the printing step and the patterning step may be carried out under partial, substantially complete, or complete vacuum conditions.

Detailed embodiments will now be discussed with reference to the accompanying drawings, in which:

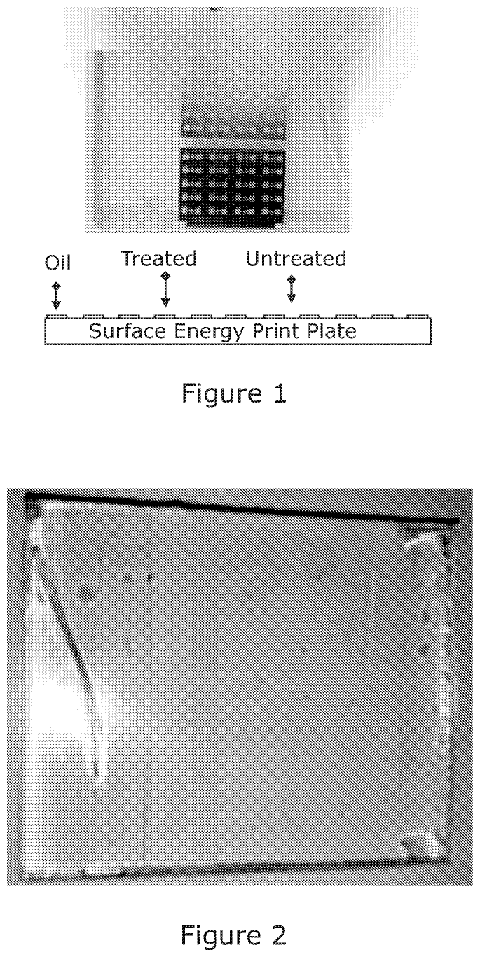

FIGS. 1 to 4 show selective ozone treatment of PDMS;

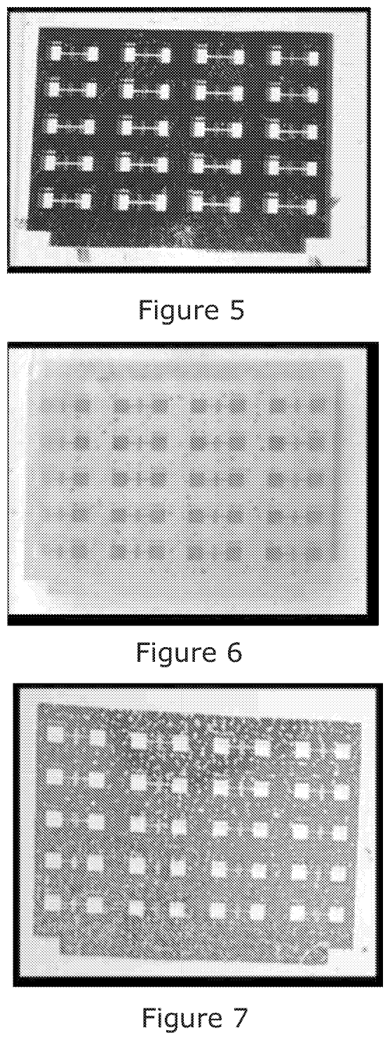

FIGS. 5 to 7 show subsequent oil coating of three different samples of PDMS;

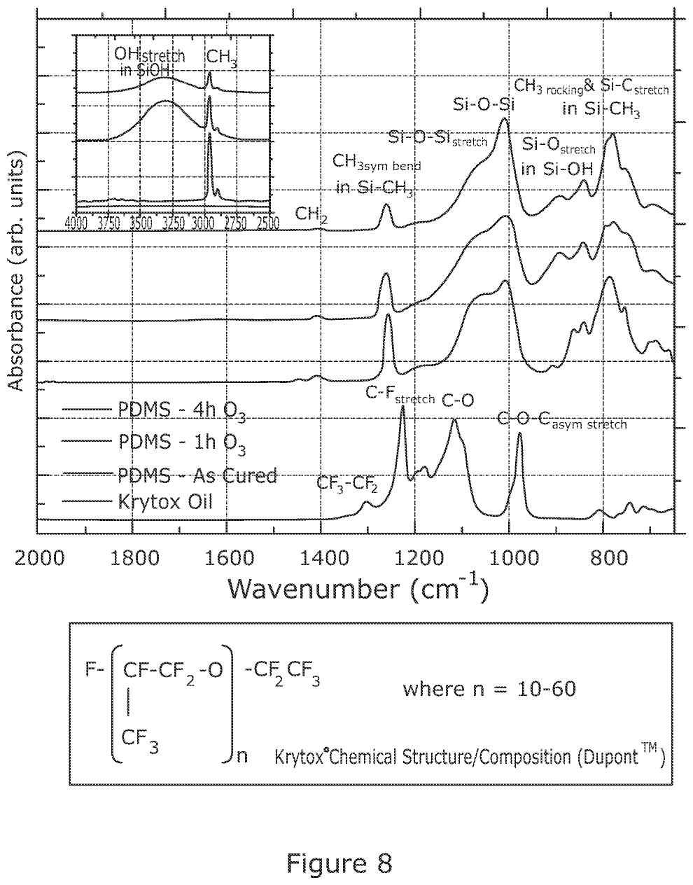

FIG. 8 shows an FTIR of Krytox 1506 oil (alongside its chemical structure), and PDMS samples;

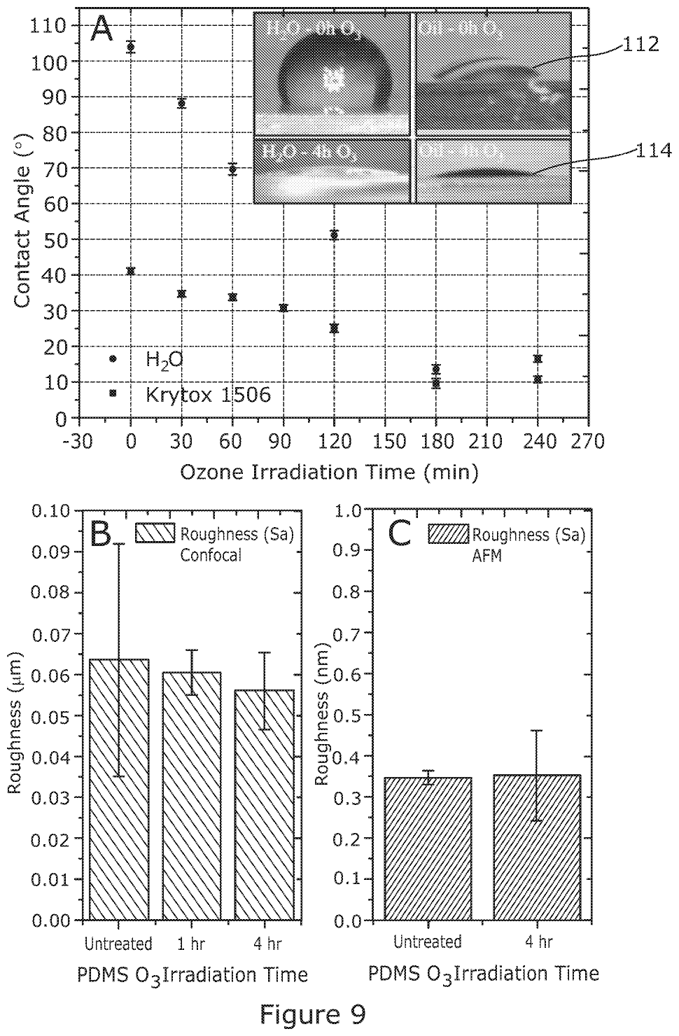

FIG. 9(A) to (C) show contact angle measurements for water and Krytox 1506 oil on PDMS, and the roughness values of PDMS after different amounts of ozone irradiation;

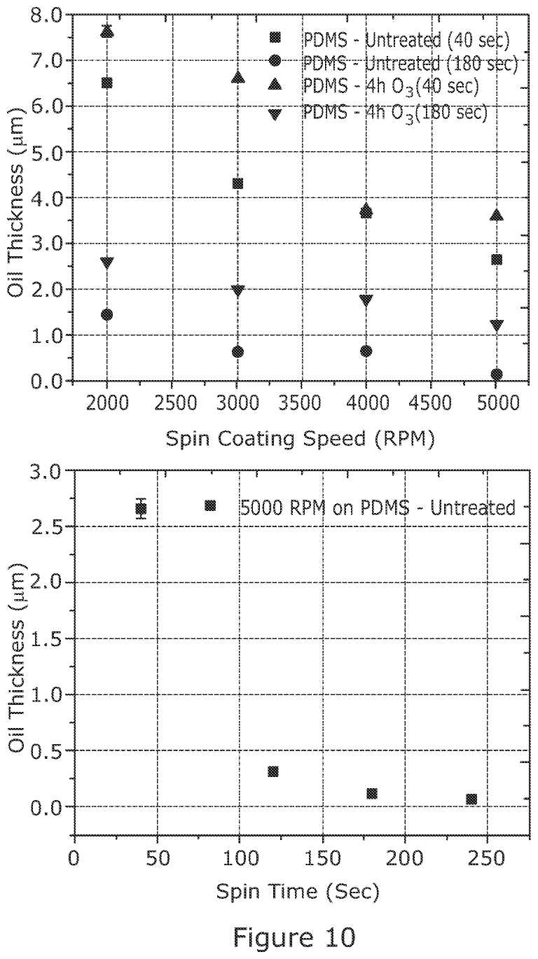

FIG. 10 shows oil thickness of Krytox 1506 oil on PDMS before and after ozone irradiation treatment;

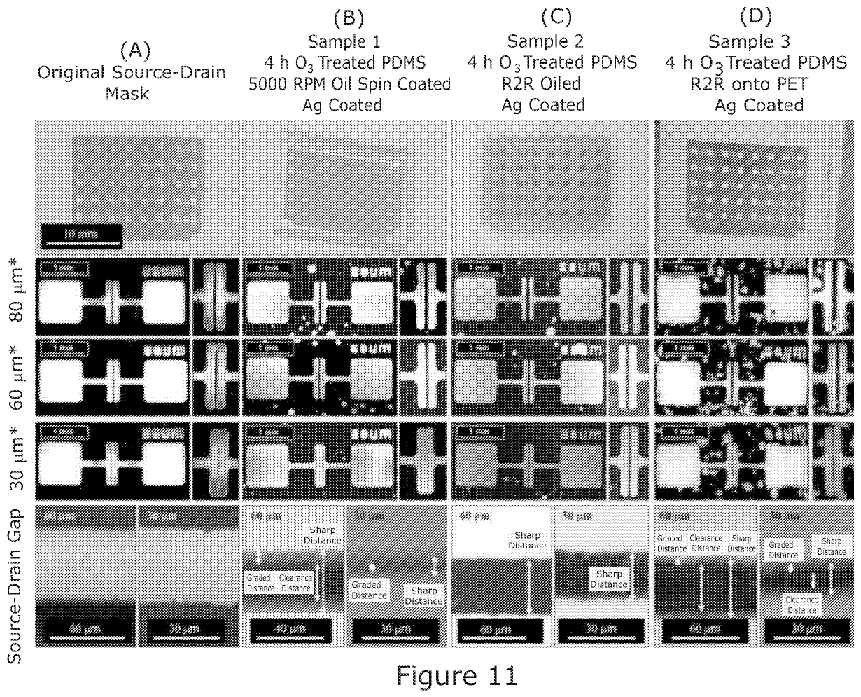

FIGS. 11(A) to (D) show micrographs of patterned source-drain samples following selective ozone irradiation treatment;

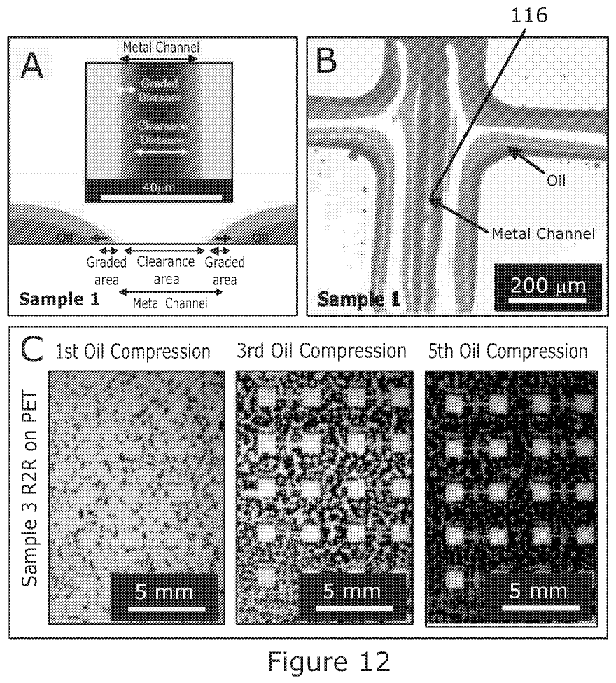

FIGS. 12(A) to (C) show, respectively, oil thinning toward mask edges, post deposition SEM micrographs of oil constrained within the ozone treated channel, and the pattern of oil transfer from the PDMS stamp to a PET substrate during different numbers of oil applications;

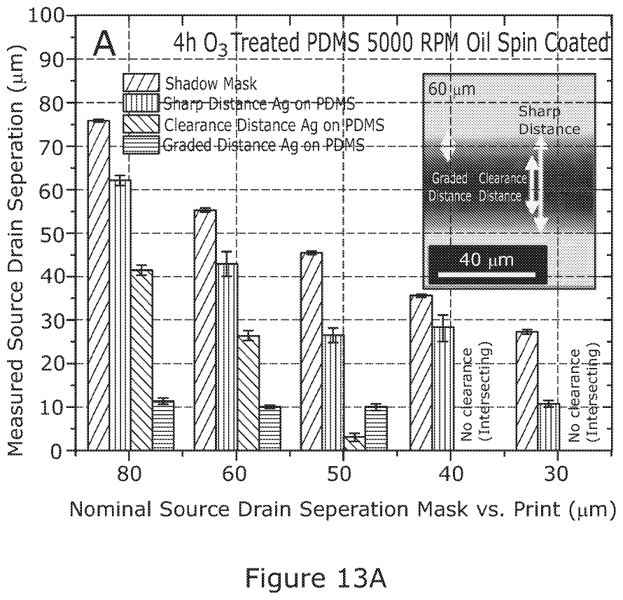

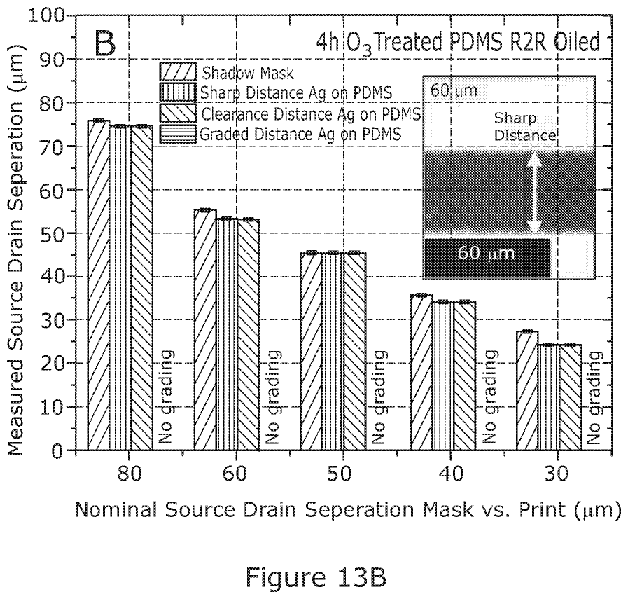

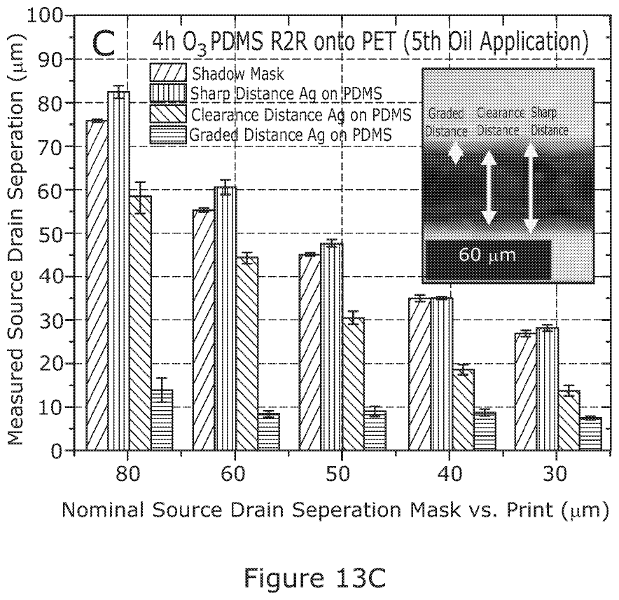

FIG. 13(A) to (C) show the measured width of Ag deposition in the OTFT source-drain gap of different PDMS samples following ozone treatment compared to nominal source-drain gaps;

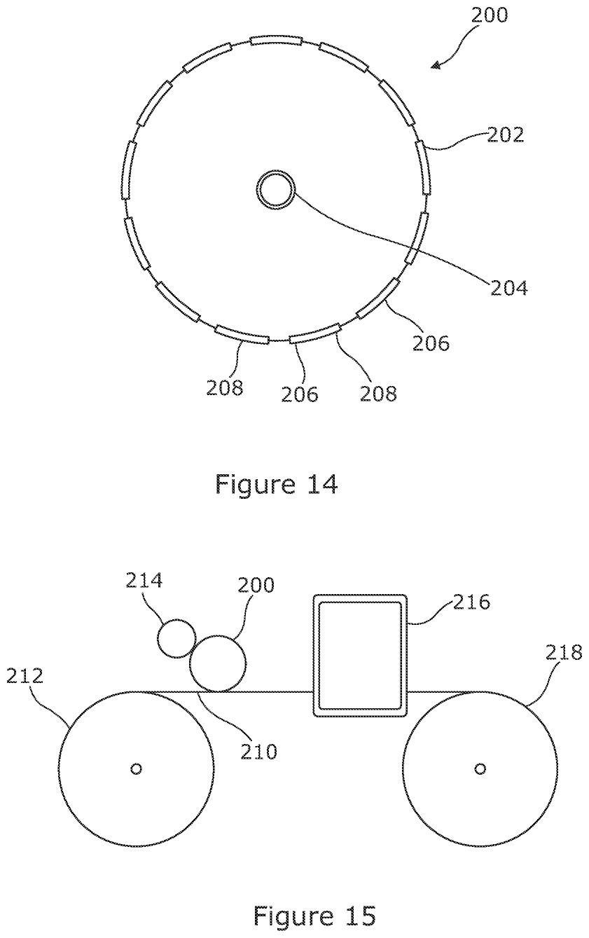

FIG. 14 shows a simplified depiction of a print head according to the first aspect;

FIG. 15 shows a simplified depiction of a roll-to-roll flexography process using the print head of FIG. 14;

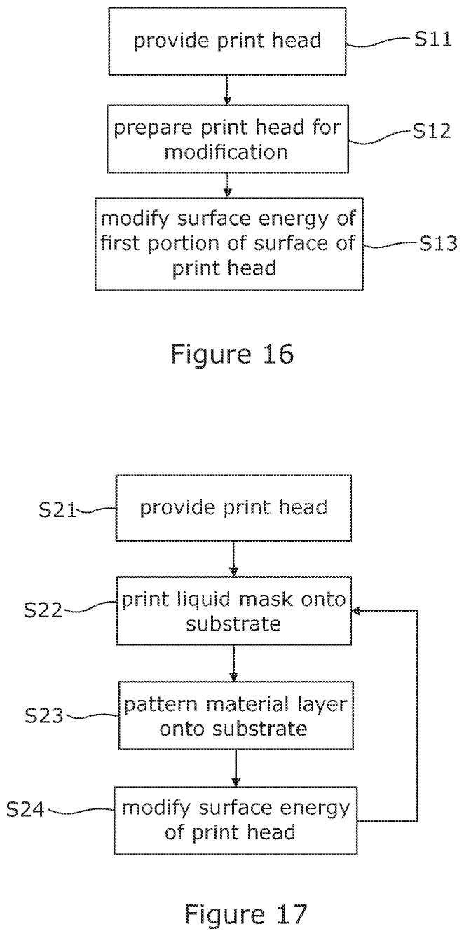

FIG. 16 shows a method of producing a print head according to the disclosure; and

FIG. 17 shows a method of patterning a substrate according to the disclosure.

PDMS Manufacture

Polydimethylsiloxane (PDMS) was manufactured using Sylgard® 184 (Dow Corning) consisting of a silicone elastomer base and cross-linking agent. The two components were mixed for 10 minutes in a 10:1 ratio (Q—by mass, volume or moles) and degassed at 1×10⁻¹ mbar for 45 minutes. The degassed mixture was poured into a glass petri dish (110 mm diameter) to act as a mould for planar stamps or an aluminium frame mounted on glass (the frame measured 150×50×5 mm and acted as a print plate mould for roll-to-roll (R2R) processing). The mixture was cured for 1 hour at 100° C. in an oven in atmospheric conditions.

Ozone Treatment and Masking

PDMS surfaces were cleaned by sonicating in ethanol for 10 minutes then ozone treated 3 days after curing. Ma et al. (Wettability control and patterning of PDMS using UV-ozone and water immersion, Journal of colloid and interface science 363(1) (2011) 371-378) investigated the varied effect of ozone treatment with curing time showing no change after 3 days. A Novascan PSD Series Digital UV Ozone System was used to irradiate samples at a UV bulb to sample height of 5 mm. 30 μm thick field effect transistor shadow masks with source-drain gaps of 30, 40, 50, 60, and 80 μm were acquired from Ossila Ltd. For creating patterns, masks were placed on PDMS throughout the duration of ozone treatment for 30 minutes to 4 hours.

Krytox® 1506 Oil Application (Spin Coating or R2R) In one embodiment, shown in FIG. 2, 200 μL of oil was spin coated on a Laurell (Model WS-650SZ-6NPP/LITE) using speeds from 2000 to 6000 rpm and varying times of 40 to 180 seconds. Oil thickness was approximated by measuring weight change pre- and post-spin coating via a mettler Toledo Micro Excellence Plus XP Analytical Balance accurate to 0.01 mg.

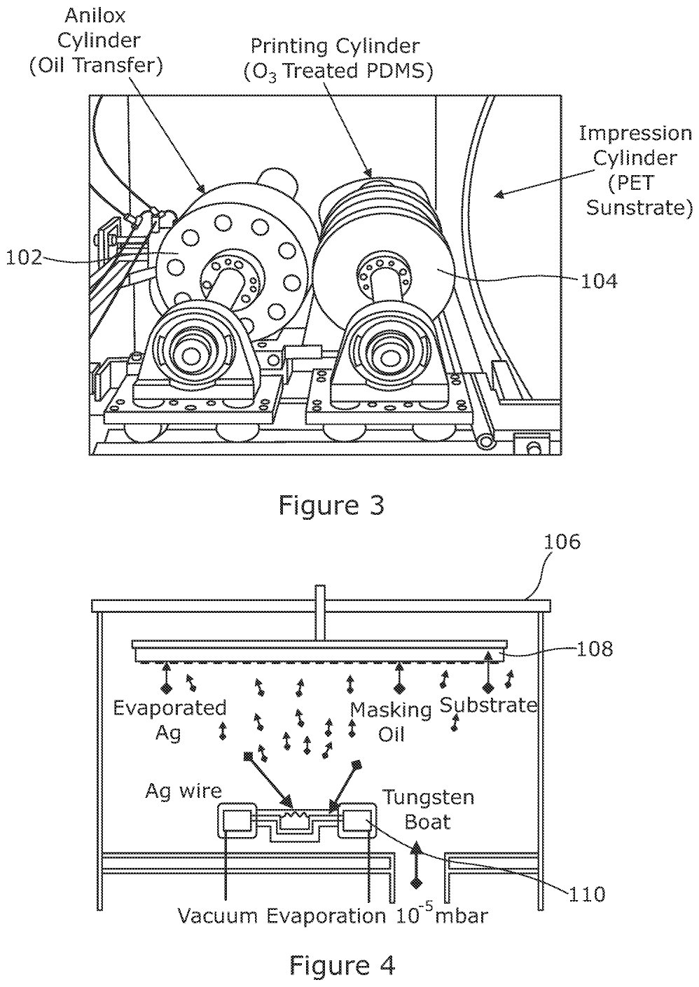

In another embodiment, to mimic a R2R flexographic printing process, a custom flexography system was tested, as shown in FIG. 3. Oil was picked up by the anilox 102, wiped with a doctor blade assembly (not shown) and rolled against a PDMS print plate 104 (fixed to the plate roller) at constant impression pressure of 1 mbar at a roll speed ˜5.5±0.5 m min⁻¹.

Metal Deposition (Thermal Evaporation and Thickness)

An Edwards E306A Vacuum Thermal Evaporator 106 was used to deposit a thin layer of Silver (99.9% Purity, acquired from Argex Ltd, as 1 mm wire) on to the patterned PDMS 108 or 12 μm thick PET samples, as shown in FIG. 4. Silver was evaporated from a tungsten boat 110 (Buhler GmbH). A base vacuum pressure of 9×10⁻⁶ mbar was achieved following consecutive rotary (10 min) and diffusion pumping (30 min) stages. Silver thickness was kept consistent between batches using a quartz crystal micro-balance and was subsequently measured using a Veeco DekTak stylus profilometer on partially masked and coated silicon wafers.

Although silver was added in the described method, other materials may be deposited, such as aluminium, copper, or other metals. Alternatively, materials such as semiconductors, oxides, or polymers may be deposited, including those used as functional materials in electronic products.

Contact Angle

At least n=5 individual droplets of oil were syringed onto the PDMS 10 minutes after completing ozone treatment using a 0.26 diameter syringe and imaged via a Dino-Lite digital microscope. Images were taken 10 seconds after the droplet was placed to assess static contact angle and to reduce the error caused by time dependent liquid spreading. Image-J was used to analyse contact angle from images via the plug-in “Drop Snake” (D. L. Williams, A. T. Kuhn, M. A. Amann, M. B. Hausinger, M. M. Konarik, E. I. Nesselrode, Computerised measurement of contact angles, Galvanotechnik 101(11) (2010) 2502). Drop Snake is reliant on user plotted points, air/curve boundary and drop profile, therefore the error represents the average and standard error of n=5 droplets (left and right angle), n=2 independent images whilst undertaking the repeated analyses 5 independent times.

Surface Roughness (Confocal and AFM)

A NanoFocus® AG, 2003 confocal white light source microscope was used to measure the surface macro-roughness. An Olympus UMPLFL 50× objective was fitted with a numerical aperture of 0.8 and working distance of 0.66 mm. All samples were analysed using the software μSurf® via line profiles to obtain Ra, and entire image profiles to obtain Sa values. Four 320×320 μm areas of each sample were analysed to determine if the sample surface was uniform over ozone treated and non-treated areas. Similarly, nano roughness was analysed in tapping mode using an AFM (JEOL JSTM-4200D) with NCHV-A, Bruker Ltd. tips. Each measurement represents four randomly selected locations of 0.5×0.5 μm².

Fourier Transform Infrared Spectroscopy (FTIR)

A Varian Excalibur FTS 3500 FTIR with an Attenuated Total Reflection (ATR) attachment containing a diamond crystal and ZnSe lens was used to measure absorption spectra in the wavenumber range 500 to 4000 cm⁻¹ with a resolution of 4 cm⁻¹.

Thickness Measurement

Ag coating thickness on PDMS was measured by stylus profilometry using a Bruker Dektak 6M. Thicknesses represent the average of n=6 edges between coated and masked regions. Prior to measurement excess in oil masked regions was removed.

Results and Discussion

PDMS has been frequently used for microfluidic channels and for micro-contact printing, benefitting from submicron topographical conformity (S. Hassan, M. Yusof, S. Ding, M. Maksud, M. Nodin, K. Mamat, M. Sazali, M. Rahim, Investigation of Carbon Nanotube Ink with PDMS Printing Plate on Fine Solid Lines Printed by Micro-flexographic Printing Method, IOP Conference Series: Materials Science and Engineering, IOP Publishing, 2017, p. 012017). Here we show that ozone (O₃) treated PDMS may be used independently to produce stamps by facilitating localised de-wetting via altering surface chemistry. This could be applicable to roll-to-roll (R2R) selective metallization of vapour deposited patterned electronics. The process images shown in FIGS. 1 to 4 illustrate the development of the manufacturing process with multiple final products culminating in a masking technology usable in R2R manufacturing; from initial oil application on PDMS, to mask transfer onto PET.

A patterned PDMS elastomer substrate/print stamp with oil applied by spin coating (FIG. 5) or by R2R oil transfer (FIG. 6) and the final stage of R2R patterning onto PET by PDMS stamp-to-PET contact (FIG. 7). In Step 1, shown in FIG. 1, PDMS was selectively ozone treated through a patterned organic field effect transistors source-drain shadow mask. The influence of O₃ treatment to facilitate selective wetting was tested by spin coating in Step 2a, shown in FIG. 2. Ultimately, masks produced using oiled PDMS (by spin coating) in Step 2a and on oiled PDMS (by R2R oil transfer) were shown to be effective for masking selectively treated areas for subsequent Ag thermal evaporation (Step 3a, shown in FIG. 6). Secondly, the ability to use treated and oiled PDMS as a R2R stamp on PET was also tested and showed promise in Step 3b (FIG. 7).

Contact Angle and Structural Variation (FTIR)

Untreated PDMS is limited in application due to natural hydrophobicity (contact angle of 105° with H₂O). However, surface modification by O₃ irradiation has led to contact angle diminishing linearly with process time to 15° by 180 min as shown in FIG. 8.

The mechanism of O₃ production is the reaction of molecular oxygen with O₂ which had been dissociated into free oxygen radicals by ultra-violet (UV) radiation. O₃ reacts with the PDMS surface to transform from hydrophobic to hydrophilic via the substitution of the non-polar methyl group in Si—CH₃ with the polar hydroxyl group to form Si—OH Silanols at the surface thereby attracting H₂O. Untreated PDMS is predominantly dispersive 0.019 vs. 0.010 J/m², attributed to the prevalence of Si—CH₃ bonds.

The FTIR spectra presented in FIG. 8 show the emergence of Si—OH groups at ˜900 and ˜3300 cm⁻¹ present after 1 and 4 hours of O3 treatment and confirm the substitution of Silanol with methyl groups by the relative reduction of infrared absorption associated with the Si—CH₃ at ˜1260 and ˜2950 cm⁻¹ (A. E. Ozgam, K. Efimenko, J. Genzer, Effect of ultraviolet/ozone treatment on the surface and bulk properties of poly (dimethyl siloxane) and poly (vinylmethyl siloxane) networks, Polymer 55(14) (2014) 3107-3119). Brunauer et al. reported the relatively high surface energy of pure Silanol in hydrous amorphous silica to be 0.129 J/m², above that of H₂O (0.072 J/m²) (K. Efimenko, W. E. Wallace, J. Genzer, Surface modification of Sylgard-184 poly (dimethyl siloxane) networks by ultraviolet and ultraviolet/ozone treatment, Journal of colloid and interface science 254(2) (2002) 306-315). In comparison, untreated PDMS values are considerably lower, ranging from 0.016 to 0.024 J/m² to suggest that a conversion of the structure to Silanol groups would in fact lead to the observed hydrophilic transformation; an effect widely confirmed in literature (K. Ma, J. Rivera, G. J. Hirasaki, S. L. Biswal, Wettability control and patterning of PDMS using UV-ozone and water immersion, Journal of colloid and interface science 363(1) (2011) 371-378). In support of this, Efimenko et al. found that surface energy of O₃ treated PDMS increased from ˜0.016 to ˜0.070 J/m² (similar to H₂O), reaching a maximum by 60 min irradiation time (K. Efimenko, W. E. Wallace, J. Genzer, Surface modification of Sylgard-184 poly (dimethyl siloxane) networks by ultraviolet and ultraviolet/ozone treatment, Journal of colloid and interface science 254(2) (2002) 306-315).

The interaction between solid PDMS and liquid perflouropolyether (PFPE Krytox® Oil) was markedly dissimilar and showed a reduction in contact angle from 400 to 9° (FIG. 9(A)) for untreated 112 and O₃ treated PDMS 114 respectively. The initial contact angle was lower (40°) explained by van der Waals liquid-surface interactions whilst the comparable reduction in surface tensions of Krytox® 1506 Oil compared to H₂O (0.016 to 0.020) vs. (0.072) J/m² led to greater liquid wetting of the former on PDMS.

Following O₃ treatment, Krytox® oil contact angle reduced to 9°±1 attributed to the increased surface energy of PDMS of 0.070 J/m² as reported by Efimenko et al (K. Efimenko, W. E. Wallace, J. Genzer, Surface modification of Sylgard-184 poly (dimethyl siloxane) networks by ultraviolet and ultraviolet/ozone treatment, Journal of colloid and interface science 254(2) (2002) 306-315). Krytox is neither polar nor dispersive, as such no innate attractions between C—F and Si—OH groups have been suggested and wettability may be dominated by surface energies/tensions. A distinct challenge associated with PDMS treatment is hydrophobic recovery over a number of days, caused by outwards diffusion of oligomers in the untreated subsurface ascribed to the extraordinarily low glass transition (Tg) of PDMS (−121°) permitting continuous molecular diffusion (J. Zhou, A. V. Ellis, N. H. Voelcker, Recent developments in PDMS surface modification for microfluidic devices, Electrophoresis 31(1) (2010) 2-16). It should be noted that this recovery was not observed while sample remained coated with Krytox® Oil over three days.

Topography (Confocal and AFM)

Roughness measurements by both confocal microscopy and AFM showed roughness scales over 100×100 μm (typical size of topographical relief features) or 500×500 nm scale (able to influence liquid wetting). Surface roughness for untreated PDMS by confocal microscopy was 60±30 nm (FIG. 9(B)) whilst AFM of untreated and 4 hours O₃ treated PDMS both exhibited identical surface roughness of 0.35 nm (FIG. 9(C)), confirming that ozone irradiation had no effect on manipulating surface topography.

Generally as observed by Wenzel, an increase in surface roughness up to hundreds of micrometres would increase surface de-wetting (H. Nakae, R. Inui, Y. Hirata, H. Saito, Effects of surface roughness on wettability, Acta materialia 46(7) (1998) 2313-2318). Since neither roughness variation nor de-wetting were observed, it is supported that van der Waal forces and polar attractions dominate liquid wetting on the nanoscale for Krytox® Oil and H₂O respectively and additionally no topographical alterations at the scale of hundreds of micrometres (able to increase wettability or within the order of magnitude of print resolutions (30-80 μm) were present.

Spin Coating and Krytox® Oil Distribution

Krytox® oil was distributed over the PDMS surface by spin coating to observe the effect of increased wettability by ozone treatment on oil thickness. Multiple mechanisms for the functionality of oil masking during vapour deposition have been suggested in literature:
i. Masking oil reaches its vaporization temperature following radiant heating from the evaporation source, generating a repelling vapour cloud [6].
ii. Condensation energy of depositing metal leads to oil ablation, preventing deposition.

In either situation, creating regions of differential oil thickness would lead to prolonged oil masking in thicker regions. The intention here was to achieve an oil thickness following ozone treatment which mimicked optimal oil transfer during R2R manufacturing from anilox cylinder 102 to print cylinder 104 (shown in FIG. 3). In the two publications demonstrating oil masking with vapour deposition using Krytox® 1506, firstly Cosnahan et al. approximated that the theoretical oil mask thickness to achieve optimal patterning, i.e. the situation where the mask would be sufficiently thick to repel condensing metal throughout the deposition time, was ˜1.6±0.3 μm when operating an oil patterned R2R substrate at 2.4 m min⁻¹ and depositing 30-50 nm thick electrodes (T. Cosnahan, A. A. Watt, H. E. Assender, Modelling of a vacuum metallization patterning method for organic electronics, Surface and Coatings Technology (2017)). Secondly Stuart et al. deposited 37 nm Al electrodes with oil thickness ˜204±75 nm when operating at 25 m min⁻¹. Therefore, as the Ag metallization here was undertaken on a static oil masked sample, spin coating conditions were derived to be within the range from 0.2 to 1.63 μm where achievable oil thinning by spin coating was ultimately limited by fluid viscosity and oil/surface interactions between oil and PDMS.

Centrifugal forces were increased by varying spin coat speed from 2000 to 5000 RPM causing an apparent reduction in oil thickness. Oil thickness was minimized where attraction between PDMS and Oil was lowest (40° contact angle as in untreated PDMS) whereas the increased attraction (9° contact angle as in 4 hours O₃ treated) prevented oil from imparting the surface attributed to greater van der Waal attraction. In all cases, extending spin duration from 40 to 240 seconds showed a hyperbolic reduction in oil thickness, plateauing between 180 to 240 seconds. Oil thickness of 1.24 μm was achieved and was within the desired range from spin coating at 5000 RPM for 180 see on the 4 hours O₃ treated PDMS surface (FIG. 10).

Masking Quality

Metallization resolution was observed at each successive print stage illustrated in FIGS. 1 to 4 on both PDMS and PET. It should be noted here that the metallization region was “inverted” such that masking occurred within the intended source-drain pattern. To obtain Ag source-drain electrodes in future a self-supporting mask for each electrode would be required. As shown in FIG. 11(A), nominal source-drain separations varied from 30 to 80±7 μm as quoted by the manufacture (Ossila, Source-Drain Deposition Masks for High-Density OFETs. https://www.ossija.com/prodcts/ofet-source-drain-mask-high-densty)]. The shadow mask's source-drain gap was sharply defined, termed here “sharp distance” for the purpose of comparative measurements.

Sample 1 (4 h O3 Treated PDMS 5000 RPM Oil Spin Coated, Ag Coated)

FIG. 11(B) successfully shows that selective de-wetting between O₃ treated and untreated regions was achieved by spin coating (a relatively harsh separation condition using centrifugal separation, compared to eventual R2R operation). Ag coating thickness was measured as 519±17 nm. As intended, Ag deposition did not occur within the treated regions. Shortcomings were observed, specifically that: i) stray oil spots and oil splatter were randomly present forming masked nodules, and ii) imaging of the source-drain gap revealed a “graded distance” of Ag encroaching inwards to narrow the line width, reducing intended thickness, which in the most narrow 30 μm nominal separation led to no “clearance gap” present, leading to intersection of graded Ag (FIG. 11(B)). Grading may have been caused by: i) oil advancing beyond the masked boundary from centrifugal spreading whilst spin coating and ii) as oil thins at the droplet edge, over metallization may have led to shrinkage of the oil droplet and graded edges as illustrated in FIG. 12(A). SEM micrographs of the print showed remaining oil after the deposition within treated channels 116 (FIG. 12(B)) to suggest that post process oil removal is necessary and deposition could continue until all oil evaporates from the channels 116. The measured graded distance was ˜9.5 to 11.6 μm, seemingly independent of nominal gap size of 60 to 80 μm and graded Ag intersected for 40 and 30 μm nominal gaps whilst clearance distances ranged from 2.6 to 41.4 μm for shadow mask widths of 45.5 and 76.1 μm respectively (FIGS. 11(A), (B) and 13(A)). Notably oil spreading/grading led to significant narrowing of the Ag line clearance distance with respect to the O₃ treated area such, where shrinkage ranged from 46 to 94% and whilst this could be perceived as a challenge, if predictable could be a route to making micron or nano-features as shown by the 2.6 μm Ag channel.

Sample 2 (4 h O3 Treated PDMS Roll-to-Roll Oiled, Ag Coated)

Oil was subsequently applied by R2R onto PDMS, in all cases (down to 30 μm nominal source-drain gap), sharp separation distances and better conformity between measured mask width and deposited Ag channel width were observed, shrinking by between 1 and 11% with respect to the mask widths as shown in (FIGS. 11(C) and 13(B)). Masked nodules were again randomly present, caused by oil droplets transferring to the PDMS. Demonstrated sharp/clearance distances were 24-74 μm vs. measured nominal gaps of 27-76 μm respectively (FIG. 12(B)) Ag coating thickness was measured as 569±17 nm.

Sample 3 (4 h O3 Treated PDMS Roll-to-Roll onto PET, Ag Coated)

As the intended application for future commercial scale processing relies of R2R oil pick up by a PDMS stamp and transfer onto a PET substrate, the process was conducted such that oil was picked up by PDMS and transferred to PET via R2R followed by five or more successive stamp-to-substrate compressions. Ag coating thickness could not be directly measured using profilometry as the macro-scale roughness of the PET prevented identification of the sample edge. Patterns following PDMS to PET compression one, three and five showed gradual improvement in the developed pattern with compression one showing the consequence of over oiling of the PDMS stamp and subsequent compression leading to oil spreading on the PET substrate. Compression five was measured termed “Sample 3” as shown in FIG. 11(D). Oil quantities may be improved in future by thinning the oil layer on the anilox roller prior to transfer onto the PDMS stamp. In a continuous R2R process the stamp is re-oiled with each rotation. Sharp source drain gap widths exceeded nominal shadow mask widths by 2 to 6 μm for 76 and 27 μm gaps respectively whilst clearance varied from from 56 to 14 μm; overall shrinkage of 20 to 49%. A graded Ag distance was observed and remained consistent between 7 to 12 μm attributed to liquid spreading during stamp to substrate compression (FIG. 13(C)).

FIG. 14 shows an example print head 200. The print head is flat, having a cylindrical outer surface 202 and rotating about a central axle or axis 204. By flat, it is meant that the surface 202 has a constant radius from the central axis 204, although it is of course curved around the axis 204. The surface 202 therefore does not have a changing profile.

The surface 202 includes a plurality of first portions 206, which have a first surface energy produced by one or more of the processes described above, and a plurality of second portions 208, which have a second surface energy. Two of the first portions 206 and two of the second portions 208 are labelled, for clarity. In the present embodiment the second surface energy is the original surface energy of the material making up the print head. The material of the depicted print head 200 is PDMS, although other materials may also be used.

A simplified depiction of a roll-to-roll flexography process including the print head 200 is then shown in FIG. 15. The process shows a substrate 210 being fed from a first roller 212, past the print head 200, which deposits oil or another liquid onto the substrate from its surface 202. The liquid is deposited from an anilox roller 214 in contact with the print head 200.

The substrate 212 then passes through a metallisation chamber 216 where a selective metallisation process is carried out to deposit a layer of metal onto the substrate 212 in the areas where the liquid is not present. Finally, the substrate 212 is received on a second roller 218.

It will be apparent that the depiction is of a simplified process and details and variations in the process will be apparent to the skilled person in view of the disclosure provided herein.

Embodiments of methods of the present disclosure are shown in FIGS. 16 and 17.

In FIG. 16, a method of producing a print head is shown. Such a print head may be used in the flexographic process shown in FIG. 15. A print head is first provided S11, for example one made from PDMS. A preparation step S12 is provided to prepare the print head for modification. In the present embodiment, a shadow mask is applied to the print head in the preparation step S12. A modification step S13 is then completed whereby the print head is subjected to ozone irradiation to modify the surface energy of the areas of the print head that are not protected by the mask.

FIG. 17 is a method of patterning a substrate. A print head is first provided S21, which includes first portions and second portions of a surface which have different surface energies, as described above. In a printing step S22, a liquid mask is applied to the substrate by the print head. In a patterning step S23, a material is deposited onto the substrate in the places where the liquid mask has not been deposited.

In an optional modification step S24, the print head may be modified such that the first and second portions are altered in comparison to the first time the print head was used. The print head may then be used in a subsequent printing step S22. The modification step S24 may be replaced with a replacement step whereby the print head is replaced with a different print head having a different arrangement of first and second portions.

Various modifications may be made to the specific embodiments disclosed herein. In particular, the present disclosure may be applied more broadly and its benefits realised in a wide range of applications, including the manufacture of electronics products, e.g. patterned flexible and/or stretchable electronics.

It will be appreciated, for instance, that Krytox® 1506 oil is a convenient example of a suitable oil that may be applied to the print head. Krytox® 1506 was readily available to the inventors, since it is used in the vacuum apparatus. Other similar oils could be equally suitable.

Any liquid may be utilised that will self-organise into a pattern on the flat surface, the pattern being determined by the selective modification of the surface energy of one or more portions of the flat surface. The liquid may comprise an oil or an ink.

Key characteristics to consider when selecting a suitable liquid, e.g. oil or ink, may include: vapour pressure, viscosity and surface energy. The liquid chosen may vary depending upon the material(s) of the flat surface and/or the manufacturing process in which the print head is to be used.

Other techniques may be used to selectively modify the surface energy of the flat surface of the print head.

For example, one or more photoinitiators other than ozone may be utilised, either instead of or as well as ozone. These photoinitiators may be in the vapour over the sample (like the ozone) or within the polymer itself.

As an alternative or in addition to using a photoinitiator such as ozone, the flat surface may be selectively exposed to focussed radiation, in order to modify selectively the surface energy of one or more portions of the flat surface of the print head. For example, an electron beam or an ion beam may be used to modify selectively the surface energy of one or more portions of the flat surface.

Conveniently, as compared with the use of a photoinitiator such as ozone, the use of focussed radiation such as an electron beam or an ion beam to modify selectively the surface energy of one or more portions of the flat surface of the print head may not require the use of a shadow mask.

By applying the teaching of the present disclosure to selectively modify the surface energy of the flat surface of the print head, the resolution achievable using flexographic printing can be improved to such an extent that, for example, roll-to-roll flexographic printing could be utilised to manufacture products requiring high resolutions, in particular electronic products, e.g. patterned flexible and/or stretchable electronic products. Consequently, roll-to-roll flexographic printing may become a commercially viable process for use in mass production of, for example, electronic products.

Typically, flexographic printing using known profiled print heads has a resolution of no better than around 20 μm. Such relatively poor resolution is not good enough for use in the manufacture of electronic products and is the main reason why flexographic printing has mainly been used commercially to date for decorative printing.

Using the teaching of the present disclosure, it is envisaged that much better resolutions may be realised, e.g. resolutions of 5 μm or less, 1 μm or less or 0.5 μm or less. Resolutions of less than 100 nm will be achievable, e.g. resolutions of approximately 20 nm. Using an electron beam to modify selectively the surface energy of one or more portions of the flat print head may enable particularly fine resolutions to be realised. By enabling the realisation of such finer resolutions, the present disclosure may help make it feasible to use flexographic printing for additional applications other than decorative printing such as the manufacture of electronic products.

Moreover, the use of print heads and methods according to the present disclosure may allow improved printing using profiled print heads, for example by microcontact printing, by increasing the adhesion of the inks to the surface of the print head.

1. A print head comprising a surface having a first portion with a first surface energy and a second portion with a second surface energy that is different from the first surface energy.

2. The print head according to claim 1, wherein the difference in surface energy causes localised de-wetting of a liquid applied to the print head.

3. The print head according to claim 1, wherein the print head is planar; or wherein the print head is cylindrical or constitutes a portion of a cylinder and/or is rotatable about an axis.

4. (canceled)

5. The print head according to claim 1, wherein the flat surface comprises an elastomeric material, such as PDMS, photopolymers such as nyloflex, butadiene, or nitrile elastomers.

6. The print head according to claim 1, wherein the difference in the first surface energy and the second surface energy is provided by an ultraviolet ozone irradiation process.

7. The print head according to claim 1, wherein the difference in the first surface energy and the second surface energy is provided by an electron beam treatment process or an ion beam treatment process.

8. A method of producing a print head, the method comprising:
a modification step of modifying a surface energy of a first portion of a surface of a print head such that it is different from a surface energy of a second portion of the surface.

9. The method according to claim 8, wherein the surface is a flat surface.

10. All method according to claim 8, further comprising a preparation step of applying a shadow plate or a patterned aperture to the print head for acting as a stencil during the modification step.

11. The method according to claim 8, wherein: the modification step includes applying ultraviolet ozone irradiation to the print head through the shadow plate or patterned aperture; and/or the modification step includes applying a radiation process to the print head, such as an electron beam treatment process, an ion beam treatment process, or a direct UV irradiation process.

12. (canceled)

13. A flexography apparatus comprising:
the print head according to claim 1; and
an applicator configured to apply a liquid or vapour to the print head.

14. The flexography apparatus according to claim 13, further comprising a roll-to-roll substrate feeder configured to pass substrate from a first roll, past the print head for printing of the substrate, and on to a second roll.

15. The flexography apparatus according to claim 14, wherein the print head is cylindrical or constitutes a portion of a cylinder and/or is rotatable about an axis, optionally wherein the applicator continuously applies liquid to the print head as the print head rotates, further optionally wherein the applicator comprises an anilox roller for applying liquid to the print head by physical contact with the print head or an evaporator for applying liquid to the print head by et evaporation.

16. (canceled)

17. The flexography apparatus according to claim 13, wherein the liquid is an oil or an ink.

18. A method of patterning a substrate, comprising:
a printing step of printing a liquid mask onto a first portion of a substrate using the print head according to claim 1; and
a patterning step of applying a material layer to a second portion of the substrate, wherein the liquid mask has not been applied to the second portion, using a an evaporation process.

19. The method according to claim 18, wherein the printing step is produced in a roll-to-roll flexography process, optionally wherein the print head is cylindrical or constitutes a portion of a cylinder and/or is rotatable around an axis and, optionally, liquid is provided to the print head during every rotation.

20. (canceled)

21. The method according to claim 18, wherein the material layer comprises one or more of: a metal such as silver, aluminium or copper; a semiconductor; an oxide; and/or a polymer.

22. The method according to claim 18, further comprising a modification step of modifying the surface energy of a portion of the print head.

23. The method according to claim 18, further comprising a modification step of replacing the print head with a further print head prior to a further printing step, optionally wherein the modification step takes place between multiple printing steps.

24. (canceled)

25. The method according to claim 18, wherein one or both of the printing step and the patterning step are carried out under partial, substantially complete, or complete vacuum conditions.
